(19) United States
(12) Patent Application Publication
(10) Pub. No.: US 2017/0031963 A1
(43) Pub. Date: Feb. 2, 2017

(54) SYSTEMS AND METHODS FOR TRACKING DATA USING USER PROVIDED DATA TAGS

(71) Applicant: MasterCard International Incorporated, Purchase, NY (US)

(72) Inventors: Christopher John Merz, Wildwood, MO (US); Joshua J. Baron, Wildwood, MO (US); Robert Grothe, Kirkwood, MO (US); Douglas W. Van Horn, St. Louis, MO (US)

(21) Appl. No.: 15/221,254

(22) Filed: Jul. 27, 2016

Related U.S. Application Data
(60) Provisional application No. 62/197,422, filed on Jul. 27, 2015.

(51) Int. Cl. G06F 17/30

(52) U.S. Cl. CPC G06F 17/30312; G06Q 20/08

(57) ABSTRACT

A method of tracking tagged transaction data corresponding to transactions between users and merchants is provided. The method includes receiving, by the tag tracking computing device, a plurality of transaction signals including a plurality of transaction data associated with the transactions. The method further includes receiving, by the tag tracking computing device, tagging data from a party, the tagging data including a tag and an identification of transaction data associated with a transaction. And, the method further includes appending, by the tag tracking computing device, the tag to transaction data stored in a database based on the tagging data from the party.

### CROSS REFERENCE TO RELATED APPLICATIONS

This application claims the benefit of U.S. Provisional Application No. 62/197,422, filed Jul. 27, 2015, which is hereby incorporated by reference in its entirety.

### BACKGROUND

The field of the disclosure relates generally to personalized digital data tracking systems, and, more specifically, to network based systems and methods that allow a user to provide personalized data to append to digital data in order to track the digital data, e.g., tagging transaction data by linking a tag with the transaction data.

There are many parties interested in tracking financial transactions between customers and merchants carried out using a payment card. These parties include, for example, cardholders, payment card issuing banks, merchants, a payment network provider, or other parties. However, it is difficult to tag and track transactions using generic tags or tags which may reveal proprietary information of the party requesting that the transaction be tracked. This is of particular concern when a party may desire to track transaction data and provide related information to another party for use in a complementary service. Furthermore, it is difficult to provide relevant information without receiving input from the party requesting the transactions to be tagged as to the content of the tag. Having a method and system for tagging payment card transactions using tag information submitted by the party requesting the tag may be beneficial to provide useful information to that party or other parties.

### BRIEF DESCRIPTION

In one aspect, a method of tracking tagged transaction data corresponding to transactions between users and merchants is provided. The method includes receiving, by the tag tracking computing device, a plurality of transaction signals including a plurality of transaction data associated with the transactions. The method further includes receiving, by the tag tracking computing device, tagging data from a party, the tagging data including a tag and an identification of transaction data associated with a transaction. And, the method further includes appending, by the tag tracking computing device, the tag to transaction data stored in a database based on the tagging data from the party.

In another aspect, a tag tracking computing device including at least one processor in communication with a memory is provided. The tag tracking computing device is in communication with a transaction processor. The processor is programmed to receive a plurality of transaction signals including a plurality of transaction data associated with the transactions. The processor is further programmed to receive tagging data from a party, the tagging data including a tag and an identification of transaction data associated with a transaction. And, the processor is programmed to append the tag to transaction data stored in a database based on the tagging data from the party.

### BRIEF DESCRIPTION OF THE DRAWINGS

FIGS. 1-6 show example embodiments of the methods and systems described herein.

FIG. 1 is a schematic diagram illustrating an example multi-party payment card system for enabling payment-by-card transactions and for enabling the processing of tagging data in accordance with one embodiment of the present disclosure.

FIG. 2 is an expanded block diagram of an example embodiment of a computer system used in processing payment transactions that includes a tag tracking computing device in accordance with one example embodiment of the present disclosure.

FIG. 3 illustrates an example configuration of a server system such as the tag tracking computing device of FIG. 2.

FIG. 4 illustrates an example configuration of a client system shown in FIG. 2.

FIG. 5 is a simplified data flow diagram for tag tracking using the tag tracking computing device of FIG. 2.

FIG. 6 is a simplified data flow diagram for tag tracking, using the tag tracking computing device of FIG. 2, of transactions related to cardholder voting for an all-star team line up, according to an exemplary embodiment.

### DETAILED DESCRIPTION

The system and methods described herein facilitate the tracking of tagged transactions between users and merchants. The system described herein (i) receives a plurality of transaction signals including a plurality of transaction data associated with transactions; (ii) receives tagging data from a party, the tagging data including a tag and an identification of transaction data associated with a transaction; and (iii) appending the tag to transaction data stored in a database based on the tagging data from the party.

The systems and method described herein are implemented by a computing device that may be referred to as a “tag tracking computing device.” The tag tracking computing device includes a processor in communication with a memory. The tag tracking computing device is configured to: (i) receive a plurality of transaction signals including a plurality of transaction data associated with transactions; (ii) receive tagging data from a party, the tagging data including a tag and an identification of transaction data associated with a transaction; and (iii) append the tag to transaction data stored in a database based on the tagging data from the party.

As used herein, “users” refers generally to any party using the tag tracking computing device to tag transactions, view tags, or the like. For example, users include cardholders, merchants, issuing banks, or the like. As used herein “tags” refers generally to any data appended to transaction data in a tagging process carried out by the tag tracking computing device. For example, a tag may be or include of a purchase receipt, a product manual, a hyperlink, rewards program information, a recall notice, a warranty offer, an advertisement, or the like. A tag may be data in a text format, image format, hyperlink format, or the like. A tag may be in the form of a database entry that links to additional data such as that described above.

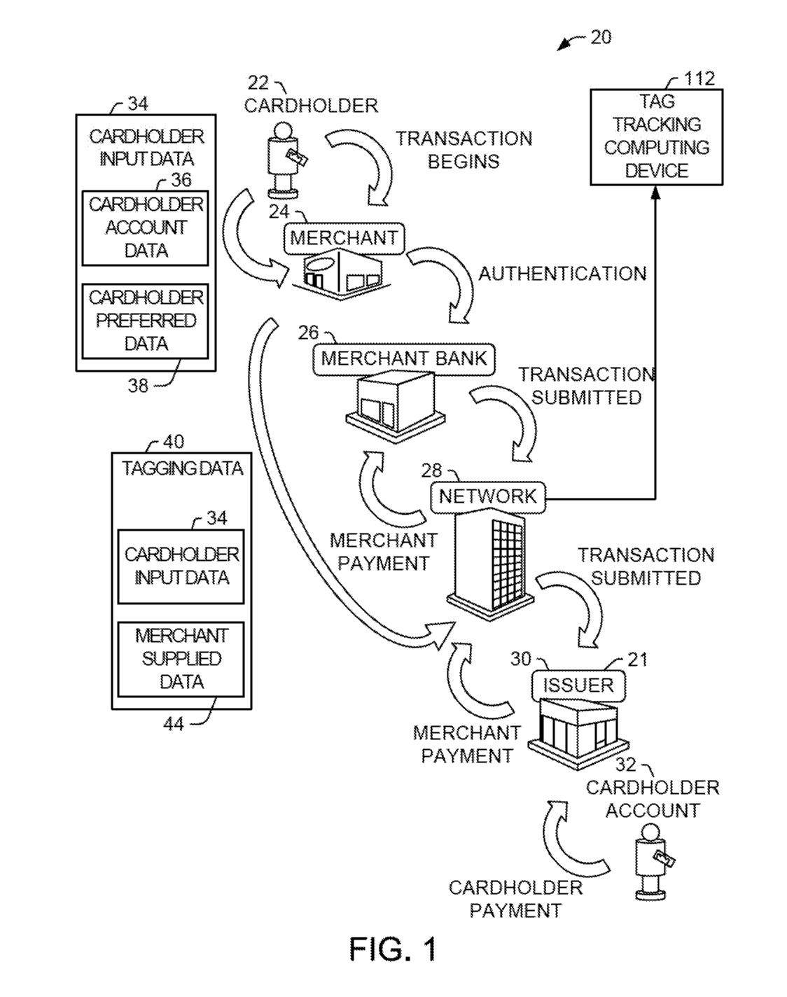

Generally, the tag tracking computing device has access to transactions signals generated as part of a payment-by-card transaction. For example, a payment network, as described in more detail with reference to FIG. 1, may process transaction signals including transaction data such as a transaction amount, date of transaction, card present indication (e.g., indication that the transaction is not an online transaction), cardholder identifier, merchant identifier, primary account number (PAN), a merchant category code (MCC), and/or other data. The tag tracking computing device receives tagging data from a party and tags a transaction using the tagging data. For example, the tag tracking computing device stores in a database the transaction data associated with the tagged transaction and a tag included in the tagging data provided by the party. Tagging data may include a tag and an identification of the transactions (e.g., by transaction number; card number and date; card number; PAN; or the like) to be tagged. Tagging data may further include privacy/permissions information which is used by the tag tracking computing device to determine which parties other than the tagging party has access to the tagged transaction data.

The tag tracking computing device uses the tags to track transactions of interest to the party. In order to communicate information related to tagged transactions and requested by a party (e.g., the same party submitting the tagging data or a different party), the tag tracking computing device searches the database for the tag(s) for which the requesting party has requested information. The tag tracking computing device retrieves the relevantly tagged transactions and provides associated information (e.g., the transaction data associated with the tagged transaction and stored in the database with the transaction data, analytics based on the tagged transactions, or the like).

The tag tracking computing device may receive tagging data from a variety of parties (e.g., tagging parties). Parties may include, but are not limited to, merchants, an interchange network provider, a merchant bank, a card issuer, a user (e.g., a cardholder) or the like. For example, a merchant may provide tagging data which includes a tag identifying a user who has transacted with the merchant and which specifies that some or all transactions with the merchant by the user be tagged using that tag. The transactions may be identified by providing a merchant identifier corresponding to the merchant and a cardholder identifier such as a card number or PAN. The tag may include further relevant information such as demographic information known about the user by the merchant. In this way, the merchant uses the tag tracking computing device to track all purchases from the merchant by the user made using the card. The additional information provided by the tag may increase the usefulness of the information. As a further example, merchants may further provide tracking data to track transactions by specific products to provide warranty offers, product recall notices, targeted advertisements, rewards program information, a purchase receipt, a product manual, a hyperlink or the like.

In embodiments where the tag is a hyperlink, the hyperlink directs a user to a webpage that includes information such as warranty offers, product recall notices, targeted advertisements, rewards program information, a purchase receipt, a product manual, similar products, or the like. To view the hyperlink, a user may access a list of historical transactions using a web browser or application and a website or other access system maintained by one or more of the tag tracking computing device, an issuing bank, or other party. Tagged transactions may display the tag next to information identifying the transaction, e.g., an amount, merchant identifier, timestamp, or the like. A user can interact with the tag to see additional information, e.g., a receipt, a product manual, an advertisement, or the like. If the tag is a hyperlink, interacting with the tag causes the web browser or application to navigate to and display a website associated with the hyperlink.

The tagging data received by the tag tracking computing device includes at least a tag and an identification of transactions which are to be tagged with the tag. The tagging party can identify the transaction(s) to be tagged in a variety of manners. In some embodiments, the tagging party includes the tag with transaction data sent over the payment network for processing in order to complete the payment-by-card transaction. For example, when a merchant requests authorization for a transaction from an issuing bank by providing transaction data, the merchant may include a tag with the transaction data. The tag may be entered by a point-of-sale terminal or otherwise added to the transaction data by a merchant system. This allows the merchant to identify specific transactions which are to be tagged by including the tag in the initially generated transaction data which is included in transaction signals sent and processed by the payment network. When the transaction signal is received by the tag tracking computing device the transaction data and associated tag are stored in a database.

In some embodiments, the tagging party identifies, via the tagging data, transactions which have already occurred. For example, a merchant may identify a set of transactions based on transaction data included in the previously occurred transaction such as a merchant identifier, a card number, a date range within the transaction occurred, or the like. The tag tracking computing device uses the identifying information to search a database of transaction data and identifies transactions which meet the search criteria. Identified transactions are tagged with the tag supplied by the party in the tagging data.

The tagging data supplied by the party also includes a tag. The tag is applied by the tag tracking computing device to the corresponding transaction data stored in a database. The tag is stored with the transaction data in the database allowing the transaction data to be searchable by tag. The tag can be any suitable data structure including a string, number, array, associative array, graph, object, or the like. For example, tags may have an object data structure and be compatible with object oriented programming. Tags may be sent using the following format:

```
      <key, value> =
      <txn_id, receipt_obj> =
      <PAN+Datetime+Amount, <receipt_obj, merchant_id=123,
receipt_pdf=URL>>
```

The object included in the tag may be or include a rebate offer, a customer survey, a ballot for participating in a contest, vote or promotion, or the like. The tag may be applied to any data structure, party, or the like included in the database used by the payment network or payment processor (e.g., transaction processor) and to which the tag tacking computing device has access. Anything with identification may be tagged. For example, a tag may be applied to a merchant identification, a PAN, a wallet, or the like. In some embodiments, the tag tracking computing device receives a request from a merchant to tag a transaction based on an identification of a temporary PAN used by the merchant linked to a PAN. The tag tracking computing device, e.g., using the payment network, determines a user's PAN based on the temporary PAN provided and tags the corresponding transaction. In further embodiments, tags can be applied independent of a transaction. For example, a user (e.g., a cardholder) can tag a merchant with a review independent of a transaction involving the merchant and the user. A merchant can tag a PAN with an offer independent of the merchant having had a transaction with a user associated with the PAN.

In some embodiments, tags have a structure of Entity.txn_id.pan.customer_id.paymentnetworkprovider, where the entity is a party such as a merchant, issuer, acquirer, user (e.g., cardholder), or a third party. The tag is structured like a domain name, with each level including different information. For example, the entity level identifies the tag requesting party, the PAN level identifies an account associated with one or more payment cards, the customer ID level indicates a particular card associated with the PAN, and the payment network provider level indicates the payment network handling the transaction. Further levels may be added to indicate additional information such as particular product, user demographic, rewards program, or the like. The content of this tag may include custom information provided by the requesting party.

In some embodiments, the content of the tag is determined by the requesting party such that custom tags may be used. The party may include information in the tag which is relevant to the transaction. For example, a merchant may tag a transaction with one or more tags which identify the products purchased in the transaction. This allows a merchant to track, using the tag tracking computer device, all transactions including specific products. For example, a merchant may recall a product and request from the tag tracking computing device all transaction data tagged with a particular product tag. The tag tracking computing device searches the database for transaction data associated with the tag and returns associated transaction data. The associated transaction data which is returned by the tag tracking computing device can be used to identify customers and provide recall notices to the customers who purchased the product.

In some embodiments, the content of the tag is determined in part by or includes user (e.g., cardholder) input data provided to a party by a cardholder. Cardholder input data may include cardholder account data such as a card number, PAN, cardholder name, cardholder address, and/or other information. Cardholder account information may be provided to a party when no transaction is occurring but the cardholder and/or party wish to tag/track further transactions of the cardholder. The cardholder account data provides the party with the information needed to identify transactions to be tagged in the future and is provided to the tag tracking computing device as part of the tagging data. For example, the cardholder may desire to allow a non-profit to track the cardholders transactions (e.g., the cardholder, issuing bank, or other party can make a donation based on the amount spent by the cardholder), participate in a contest (e.g., where each transaction completed by the cardholder is a vote for a contestant or chance to win a contest prize), or otherwise have transactions tagged and tracked.

User input data may also include cardholder preference data. Cardholder preference data may be included in the tagging data by the party requesting that the tag tracking computing device tag identified transactions. The cardholder preference data may additionally or alternatively be used by the party receiving the cardholder preference data and not be included in the tagging data. For example, cardholder preference data may include information such as whether a cardholder desires to receive recall notices, whether a cardholder desires to receive special offers or advertisements, whether a cardholder desires to participate in a rewards program, cardholder demographic information, cardholder product categories of interest, or the like. Cardholder preference data may further include information related to a contest or promotion. For example, cardholder preference data may include a cardholders selection of contestants for which the cardholder desires to “vote” for with each dollar spent using a card or cards identified in the cardholder account data.

User (e.g., cardholder) input data may be received using a variety of techniques. In some embodiments, tag tracking computing device receives user input, or a subset thereof (e.g., cardholder preference data) as a part of the tagging data submitted by a party. In alternative embodiments, the tag tracking computing device receives the user input data directly and not through a party such as a merchant. User input data may be received by the party and/or the tag tracking computing device from a cardholder using a client system such as smartphone or personal computer. The cardholder may provide the user input data in response to a prompt received from the party (e.g., a merchant) and/or the tag tracking computing device.

The content of a tag does not have to be standard such as stockkeeping unit (SKU) but can be designated by the party. This allows for customization and/or allows for anonymity. For example, a merchant may be unwilling to reveal SKU information to the tag tracking computing device and/or to other merchants or parties who may have access to tagged transaction. The ability to define custom tags allows a merchant to share information without revealing sensitive information, proprietary information, or information at too fine a detail. For example, a product may be generally named or a tag may refer to a product category rather than a SKU.

Tags can further include privacy/permissions information. This information is used by the tag tracking computing device to control which other parties have access to the tagged transaction data. For example, a first party which requests that transactions be tagged and provides the tagging data includes in the tag or tagging data the privacy/permissions information. The privacy/permissions information includes information which the tag tracking computing device uses to control access to the tagged transaction data. For example, the privacy/permissions information may include a category of party which does or does not have access to the tagged transaction data (e.g., no merchants have access), may specify that no other party has access, may specify that all other parties share access, may specify that a particular party does or does not have access to the tagged transaction data. The tag tracking computing device may use one or more of a variety of information control techniques to restrict access to tagged transaction data. For example, the tag tracking computing device may use the privacy/permissions information to maintain white lists, black lists, password protect tagged transaction data, change the visibility of specific tags to other parties, restrict output, and/or otherwise control access to tagged transaction data. The privacy/permissions information may further indicate for what uses other parties may use the tagged transaction data. As an example use of privacy/permissions information, a merchant may want to make tagged transactions available to other merchants who can provide a complementary, non-competing service. For example, an online retailer may tag transactions with tags indicated which shipping or delivery company is handling the purchase. The online retailer may include in the tag privacy/permissions information which adds certain shipping or delivery companies (e.g., those paying a fee to the online retailer) to a whitelist which provides those parties with access to the tagged transaction data. This allows the shipping or delivery company to provide additional services to its customers (e.g., tracking all deliveries from a particular online retailer in one place viewable by a customer rather than having separate tracking information accessed or displayed separately).

The tag may be an object which is defined in an application program interface (API) used by the tag tracking computing device. The object allows for the setting of prescribed privacy/usage limitations on the tag. For example, an online retailer can tag a transaction with a “shipping status” object whose privacy/permissions configuration allows for a certain merchant, such as a shipper, access to the tag and tagged transaction data. An example of such an object is as follows:

<MyPAN+Datetime+Amount, <shipping_status_obj, merchant_
id=OnlineRetailer_id,
authorized_merchant_list={Shipper}, ... >>

The tag tracking computing device manages tag privacy permission information. The tag tracking computing device stores tag privacy/permissions information in a database. Tag privacy/permissions information may be stored in a separate database from tagged transaction data or be stored in the same database. For example, a tag privacy/permissions value may be assigned to and stored with a corresponding set of tagged transaction data. The tag tracking computing device my further manage tag privacy/permissions information by updating the information in the database upon a request by a party. A merchant may want to change tag privacy/permissions information for a particular tag and set of tagged transactions to allow another merchant access. For example, an online retailer may tag transactions in which a particular shipping or delivery company is used to send a purchased item to a customer. The online retailer may have the tag tracking computing device set a permission value for this tagged transaction data which provides it to the particular shipping or delivery company indicated in the tag. This allows the shipping or delivery company to request tagged transaction data for the online retailer which indicates that shipping or delivery company is being used. The shipping or delivery company can use this data to provide services to the customer (e.g., package tracking for all the packages being shipped by the shipper).

In some embodiments, the tag tracking computing device may limit the types of level of tags available to parties. For example, the tag tracking computing device may refuse a request by a merchant to tag all transactions at the card number or account level for a specific cardholder. This prevents the merchant from having access to all transactions completed by the user (e.g., the cardholder). The tag tracking computing device may limit the party to requesting transactions be tagged only for transactions with a nexus to the party. As an example, the tag tracking computing device may limit a merchant to requesting transactions be tagged to only transactions which include a merchant identifier corresponding to the requesting merchant.

Tags can further include a time value for which the tag is active and for which the tag tracking computing device tracks tagged transaction data. For example, a tag may include a date range for which the tag is to be applied to transactions. If a transaction falls within that date range and also meets the transaction identification criteria provided in the tagging data, the transaction is tagged. If the transaction falls outside of the date range then the transaction is not tagged.

### Tag Tracking

Tags are appended to transaction data stored in a database which is accessible to the tag tracking computing device. The database maintains the tagged transactions such that as more transactions are added to the database, the tag is tracked. The database is updated periodically or in real time to include additional transactions processed by the payment network. Similarly, the tag tacking computing device periodically or in real time searches newly added or incoming transaction data to append tags to the transaction data. This creates an updated database of tagged transaction data which allows tag tracking computing device to track tags over time and maintain an up to date database of tagged transactions. Tags are appended to transaction data and stored with the transaction data in the database as is described in more detail herein with reference to Retroactive Tagging and Prospective Tagging.

### Output of Tagged Transactions

The tag tracking computing device may output tagged transactions in a variety of formats. In some embodiments, the tag tracking computing device outputs a list of all tagged transactions identified in a search for one or more specific tags. The list of tagged transactions may include transaction data associated with each transaction. In other embodiments, the tag tracking computing device outputs aggregated transaction data for all tagged transaction data identified in the search. For example, the tag tracking computing device may receive a request for transaction data associated with a merchant's tag for a specific product and/or another tag such a user (e.g., cardholder) demographic tag. The tag tracking computing device may search a database of transaction data for the one or more tags and return transaction data for identified transactions. The tag tracking computing device then aggregates the transaction data to provide an output such as total transaction amount for the tagged transactions. In this example, the output provided to the requesting merchant party is the aggregate sales amount for the tagged transactions which the merchant knows corresponds to a particular product and demographic. In further embodiments, the tag tracking computing device may further output the results of specific data analytics operations performed using, at least in part, the tagged transaction data.

In some embodiments, the tag tracking computing device provides a service to tagging merchants and/or other parties based on the tagged transaction data. The tag tracking computing device (e.g., operated by the payment network provider) communicates directly with user (e.g., cardholders) on behalf of the merchant or other party. For example, a plurality of merchants may tag transactions to indicate that specific products have been purchased. Based on the identification of specific products which have been purchased, the same and/or other merchants may provide an advertisement for related products, a warranty offer, a coupon, a recall notice, and/or other material to the tag tracking computing device. The tag tracking computing device transmits this material to the customer identified by the tagged transaction data on behalf of the merchant. The tag tracking computing device may format the material to provide a consistent look and feel such that to the customer it appears as though the material is being generated by one source (e.g., the payment network provider, a card issuing bank, or the like). This may make offers from a plurality of merchants easier for a customer to manage in comparison to receiving individual offers from a plurality of individual merchants. Communication to the customer by the tag tracking computing device may be completed using mail, e-mail, an application running on a user device of the customer, or the like. The communication may also make use of further intermediate computing devices which acquire information from the tag tracking computing device (e.g., tagged transaction data, customer identities associated with the tagged transaction data, or the like).

### Cardholder and Account Level Tagging

The tag tracking computing device can tag transactions at the cardholder or account level. The tag tracking computing device may receive a request from a party to tag all transactions by a user (e.g., cardholder) account with a particular tag. The tag tracking computing device uses a card identifier or cardholder account identifier, respectively, to identify transactions to tag. When transaction data includes a user identifier (e.g., cardholder identifier) such as a card number included in the tagging data, the tag tracking computing device appends the tag, also included in the tagging data, to the transaction data and stores the transaction data in the database. When transaction data includes an account identifier such as a PAN included in the tagging data, the tag tracking computing device appends the tag, also included in the tagging data, to the transaction data and stores the transaction data in the database. This allows a party to use tag tracking computing device to tag and track the transactions of a user or account. This tracking is merchant agnostic. Alternatively, the tagging data can further include additional criteria which identify the transactions to be tagged.

### Transaction and Merchant Level Tagging

The tag tracking computing device can tag transactions at the transaction or merchant level. The tag tracking computing device may receive a request from a party to tag all transactions made between any user (e.g., cardholder) and a specific party (e.g., the requesting party). For example, a merchant requesting party may identify transactions to be tagged by providing their merchant identification number. When the tag tracking computing device determines that transaction data includes the merchant identification number, the tag tracking computing device tags the transaction data. Additionally, the tag tracking computing device may receive a request from a party to tag a specific set of transactions. For example, a merchant may request that all transactions including a specific product be tagged. In this case, the merchant may provide a list of transactions and identifying information (e.g., date, card number, amount, or the like) which the tag tracking computing device uses to identify and tag transactions. Similarly, a party may identify a specific transaction to tag. For example, a merchant may identify a particular transaction (e.g., by date, card number, amount, or the like) to be tagged (e.g., to apply a tag corresponding to a product warranty offer to be made at a later time).

### Retroactive Tagging

In some embodiments, the tag tracking computing device receives tagging data from a party and applies the tags retroactively to transactions which have already occurred. The tag tracking computing device maintains or has access to a database of transaction data corresponding with past transactions passing through or processed by the payment network. When the tag tracking computing device receives tagging data, the tag tracking computing device uses the transaction identifying information included in the tagging data to search the database of prior transaction data to determine which transactions satisfy the identifying criteria. For transaction which satisfy the identifying criteria (e.g., have information which matches the identifying information), the tag tracking computing device appends the tag included in the tagging data to the transaction data and stores the transaction data and the tag in the database.

### Prospective Tagging

In some embodiments, the tag tracking computing device receives a tag from a party and applies the tag prospectively to transactions occurring after receipt of the tag. As transaction data is received by the tag tracking computing device from the payment network (e.g., as the transactions are processed), the tag tracking computing device determines if the transaction data corresponds with transaction identification information associated with a tag. If so, the tag tracking computing device appends a tag associated with the transaction identifying information to the incoming transaction data and stores the transaction data and the tag in a database. For example, a party may tag a particular user (e.g., cardholder), payment card number, account number (e.g., a primary account number or PAN), or the like. After being tagged, all transaction data stored in the database and corresponding to the user, payment card number, account number (e.g., a primary account number or PAN), or the like includes the tag. The tag tracking computing device assigns the tag to the transaction data based on the tag being assigned to the particular user, payment card number, account number (e.g., a primary account number or PAN), or the like. That allows all related transactions to be tracked via the tag. A merchant may tag a user customer by providing to the tag tracking computing device a tag and associated PAN. The tag may identify the merchant. The tag tracking computing device prospectively appends the tag to transaction data which matches the transaction identifying information associated with the tag, as it is received by the tag tracking computing device.

The technical effects of the systems and methods described herein can be achieved by performing at least one of the following steps: (i) receiving, by a tag tracking computing device, a plurality of transaction signals including a plurality of transaction data associated with transactions; (ii) receiving tagging data from a party, the tagging data including a tag and an identification of transaction data associated with a transaction; (iii) appending the tag to transaction data stored in a database based on the tagging data from the party.

The following detailed description of the embodiments of the disclosure refers to the accompanying drawings. The same reference numbers in different drawings may identify the same or similar elements. Also, the following detailed description does not limit the claims.

Described herein are computer systems such as tag tracking computing devices and user computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel. Computer devices such as the tag tracking computer device are specialized computer devices for use with a payment network described herein and perform the specialized functions described herein.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the tagging of transaction data and communication (e.g., display) of tagged transaction data and/or other analytics.

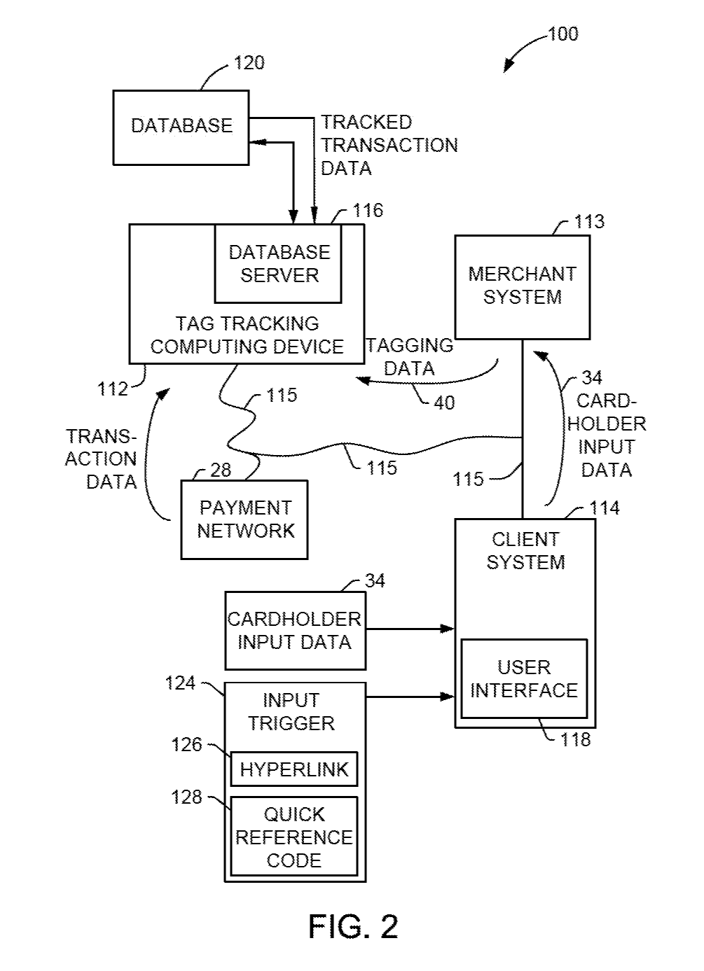

FIG. 1 is a schematic diagram illustrating an example multi-party payment card system 20 for enabling payment-by-card transactions and tracking of tagged transactions, in accordance with one embodiment of the present disclosure. FIG. 1 depicts a flow of data in a typical financial transaction through system 20, which includes a tag tracking computing device 112 (shown in FIG. 2). Components of system 20 provide tag tracking computing device 112 with transaction data, which tag tracking computing device 112 processes in combination with receiver tagging data 40 to tag transactions and track tagged transaction. Tag tracking computing device 112 provides information to one or more parties based on the tagged transactions (e.g., a list of tagged transactions and associated information such as dollar amount or analytics based on aggregated tagged transactions).

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information and/or transaction information such as a type of merchant, amount of purchase, date of purchase, and/or other information in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including tag tracking computing device 112. In the example embodiment, interchange network 28 provides such transaction data (including merchant data associated with merchant tenants of each commercial real estate asset of each portfolio record) and additional transaction data. In alternative embodiments, any party may provide such data to tag tracking computing device 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

In some embodiments, cardholder 22 (e.g., a user) provides cardholder input data 34 (e.g., user input data) to merchant 24 or another party. Cardholder input data 34 may be included in and/or used to generate tagging data 40 which is provided to tag tracking computing device 112 to identify and tag transaction data. Cardholder input data 34 includes cardholder account data 36. Cardholder account data 36 includes information which identifies the user such as a card number, PAN, cardholder name, cardholder address, and/or other information. Cardholder input data may further include cardholder preference data 38. Cardholder preference data 38 includes user specific information other than/in addition to identifying information. For example, cardholder preference data 38 may include information such as a vote for one or more contest participants, whether a user desires to receive recall notices, whether a user desires to receive special offers or advertisements, whether a user desires to participate in a rewards program, user demographic information, user product categories of interest, or the like.

In some embodiments, merchant 24 provides tagging data 40 to tag tracking computing device 112 (e.g., via network 28). In alternative embodiments, other parties provide tagging data 40. Tagging data 40 includes a tag and an identification of the transactions to be tagged with the tag. In some embodiments, tagging data 40 includes user cardholder input data 34, or a portion thereof, which merchant 24 received from cardholder 22. In alternative embodiments, tagging data 40 does not include cardholder input data 34. Tagging data 40 may include merchant supplied data 44 exclusively or in addition to cardholder input data 34. Merchant supplied data is tagging data 40 which merchant 24 provides. For example, merchant 34 may provide the tag and the identification of the transactions to be tagged (e.g., tagging criteria) as merchant supplied data 44.

As described below in more detail, tag tracking computing device 112 may be used to tag, track, and/or communicate information associated with tagged transactions. Although the systems described herein are not intended to be limited to facilitate such applications, the systems are described as such for exemplary purposes.

FIG. 2 is an expanded block diagram of an example embodiment of a computer system 100 used in processing payment transactions that include a tag tacking computing device 112 in accordance with one example embodiment of the present disclosure. In the example embodiment, system 100 is used for tagging transactions and outputting information related to tagged transactions, as described herein.

More specifically, in the example embodiment, system 100 includes a tag tracking computing device 112, and a plurality of client sub-systems, also referred to as client systems 114, connected to tag tracking computing device 112. In one embodiment, client systems 114 are computers including a web browser, such that tag tracking computing device 112 is accessible to client systems 114 using the Internet and/or using network 115. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1), e.g., users, as well as external systems used to store data, such as, cardholder input data, tagging data, transaction data, and the like. Tag tracking computing device 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment. In some embodiments, client system 114 may include merchant system 113. In additional embodiments, a client system 114 is associated with any party requesting that transactions be tagged and/or requesting output from tag tracking computing device 112 including or based on tagged transactions.

A database server 116 is connected to database 120, which contains information on a variety of matters, as described below in greater detail. In one embodiment, centralized database 120 is stored on tag tracking computing device 112 and can be accessed by potential users at one of client systems 114 by logging onto tag tracking computing device 112 through one of client systems 114. In an alternative embodiment, database 120 is stored remotely from tag tracking computing device 112 and may be non-centralized. Database 120 may be a database configured to store information used by tag tracking computing device 112 including, for example, transaction data, tags, privacy/permissions information, and/or other information. This and/or other information may be stored using any database or information storage technique. This written description describes storing information as tuples. It should be understood that this is an exemplary embodiment. Tuples may include string entries, numerical entries, file location entries, files storing a plurality of information, pages, and/or other entries. In alternative embodiments, other database storage techniques may be used in place of, or in combination with, the use of tuples. For example, information may be stored in a database using a B+ tree structure, unordered structure, ordered structure, heap files structure, hash buckets structure, and/or other structure. Information may be stored such that entries of information are linked by any type of relationship corresponding to entries in the same tuple as described herein.

Database 120 may include a single database having separated sections or partitions, or may include multiple databases, each being separate from each other. Database 120 may store transaction data generated over the processing network including data relating to merchants, consumers, account holders, prospective customers, issuers, acquirers, and/or purchases made. Database 120 may also store account data including at least one of a user (e.g., cardholder) name, a user address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a user from a merchant, and authorization request data.

In the example embodiment, one of client systems 114 may be associated with one of acquirer bank 26 (shown in FIG. 1) and issuer bank 30 (also shown in FIG. 1). For example, one of client systems 114 may be a POS device. Client systems 114 may additionally or alternatively be associated with a user (e.g., a commercial real estate owner or lender, a marketing director, a consumer, or any other end user). In the example embodiment, one of client systems 114 includes a user interface 118. For example, user interface 118 may include a graphical user interface with interactive functionality, such that output transmitted from tag tracking computing device 112 to client system 114, may be shown in a graphical format. A user of client system 114 may interact with user interface 118 to view, explore, and otherwise interact with the output. Tag tracking computing device 112 may be associated with interchange network 28 and/or may process transaction data.

Furthermore, user interface 118 allows for client system 114 to receive input and provide that input to one or more parties such as merchant system 113, tag tacking computing device 112, and/or other parties or systems. For example, client system 114 may be a computing device used by a user (e.g., a cardholder). Client system 114 receives cardholder input data 34 from cardholder 22 via user interface 118. For example, cardholder 22 may provide such cardholder input data 34 as a card number, PAN, name, address, e-mail address, phone number, and/or other cardholder account data 36. Cardholder 22 may further provide, via user interface 118, cardholder preference data 38 such as a vote for one or more contest participants, whether a cardholder desires to receive recall notices, whether a cardholder desires to receive special offers or advertisements, whether a cardholder desires to participate in a rewards program, cardholder demographic information, cardholder product categories of interest, or the like.

In some embodiments, client system 114 prompts a user (e.g., cardholder 22) to enter cardholder input data 34 in response to client system 114 receiving an input trigger 124. For example, input trigger 124 may be a hyperlink 126 which a user activates in a web browser running on client system 114. Hyperlink 126 may cause the browser to navigate to a webpage served by a party (e.g., a merchant) requesting cardholder input data 34 for use in tracking transactions. Alternatively, input trigger 124 may be cardholder 22 otherwise navigating to the webpage. The webpage requests cardholder input data 34 (e.g., by presenting a series of fields in which cardholder 22 is instructed to enter cardholder input data 34). In still further embodiments, input trigger 124 is cardholder 22 running an application (e.g., supplied by the party) on client system 114 which prompts cardholder 22 to enter cardholder input data 34 (e.g., by displaying fields for cardholder input data 34). In one embodiment, input trigger 124 is a quick reference code 128 which when scanned by a camera included in client system 114 (e.g., a smartphone) causes user interface 118 to prompt cardholder 22 to enter cardholder input data 34. For example, in response to scanning quick reference code 128 a quick reference code reader application may launch a browser and/or navigate to a webpage run by the party requesting cardholder input data 34. Alternatively, in response to scanning quick reference code 128, an application (e.g., supplied by the party requesting cardholder input data 34) may prompt cardholder 22 to enter cardholder input data 34.

Client system 114 transmits cardholder input data 34 to the party requesting cardholder input data 34 via network 115. For example, client system 114 transmits cardholder input data 34 to merchant system 113. Merchant system 113 transmits tagging data 40 to tag tracking computing device 116. In some embodiments, tagging data 40 includes all or a portion of cardholder input data 34. For example, merchant system 113 may use cardholder account data 36 included in cardholder input data 34 to identify transactions which are to be tagged in tagging data 40. This may include identifying all transactions including transaction data corresponding to the card number or PAN submitted by the user (e.g., cardholder 22) in cardholder input data 34. Merchant system 113 may further include in tagging data 40 cardholder preference data 38 received from client system 114 as part of cardholder input data 34. For example, cardholder input data 34 and specifically cardholder preference data 38 may include a user's (e.g., cardholder's 22) selection of one or more contest participants for which the user votes. This information may be included in tagging data 40 such that transactions by the user are tagged with the contestants for whom the user has voted. Each dollar, or other unit of currency, spent in a transaction may equate to one vote for each tagged contestant. Alternatively, each transaction, regardless of transaction amount, equates to one vote for each tagged contestant.

Tagging data 40 is transmitted, via network 115, by merchant system 113 to tag tracking computing device 112. Tag tracking computing device 112 uses tagging data 40 to tag transactions (e.g., transaction data). In some embodiments, tag tracking computing device 112 searches database 120 for transaction data received from payment network 28 and stored in database 120 based on transaction identification information included in tagging data 40. Transactions which are returned from the search of database 120 (e.g., as transaction identification information such as card number and merchant match the transaction identification information) are tagged using the tag included in tagging data 40. In further embodiments, tag tracking computing device receives transactions signals including transaction data from payment network 28 and upon receipt determines if the transaction meets the criteria for tagging included in the tagging data (e.g., the identification of transactions to tag). If the received transaction data does meet the criteria (e.g., the card number of the received transaction data matches a card number included in tagging data 40 as identifying transactions to tag), tag tracking computing device stores the received transaction data in database 120 with the tag, included in tagging data 40, appended to the transaction data. For example, the transaction data and the tag are stored in database 20 as a tuple.

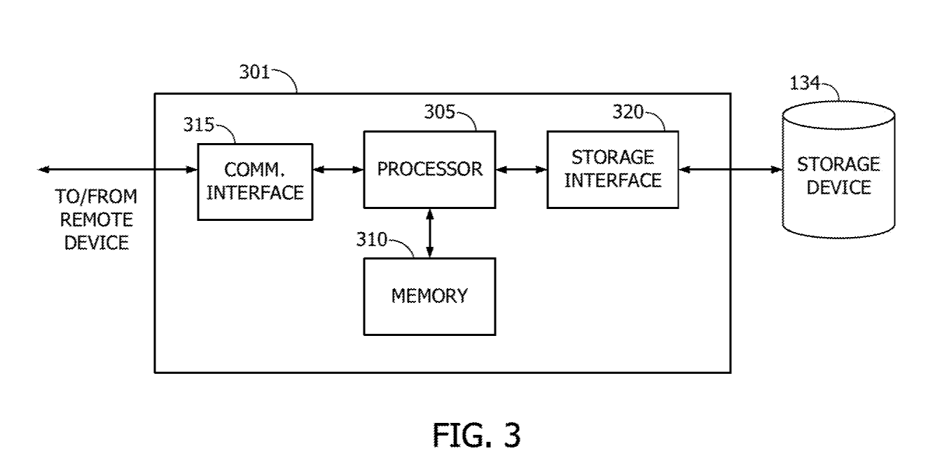

FIG. 3 illustrates an example configuration of a server system 301 such as tag tracking computing device 112 (shown in FIGS. 2 and 3) used to tag transactions and provide related output (e.g., present related output on an interactive user interface), in accordance with one example embodiment of the present disclosure. Server system 301 may also include, but is not limited to, database server 116. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests (e.g., requests to display merchant analytics and/or provide an interactive user interface) from a client system 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

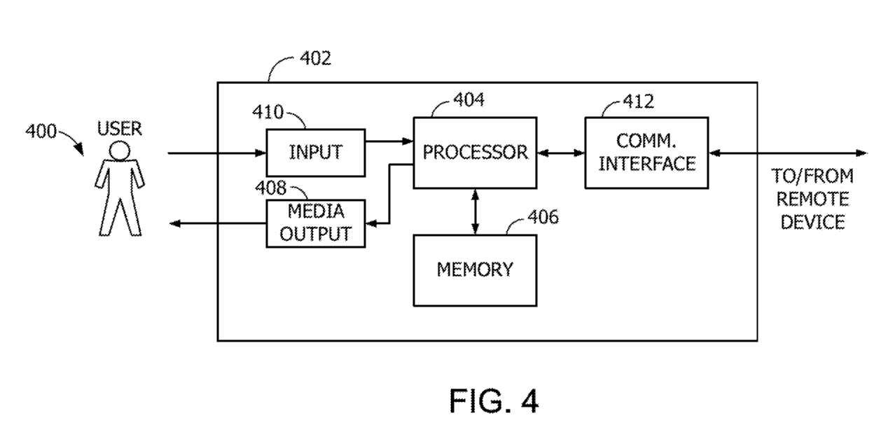

FIG. 4 illustrates an example configuration of a client computing device 402. Client computing device 402 may include, but is not limited to, client systems (“client computing devices”) 114. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400 (e.g., a cardholder 22). Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 302 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 406 are, for example, computer-readable instructions for providing a user interface to user 400 via media output component 408 and, optionally, receiving and processing input from input device 410. A user interface may include, among other possibilities, a web browser and client application. Web browsers enable users 400 to display and interact with media and other information typically embedded on a web page or a website from a web server associated with a merchant. A client application allows users 400 to interact with a server application associated with, for example, a merchant. The user interface, via one or both of a web browser and a client application, facilitates display of output from tag tracking computing device 112. The user may interact with the user interface to view and explore tagged transaction data and/or analytics generated based, at least in part, on the tagged transaction data. The client application further allows users 400 to interact with tag tracking computing device 112 to provide search queries and/or otherwise filter or retrieve specific tagged transaction data. For example, users 400 may enter a specific set of tags using the user interface. The specific set of tags are transmitted by client computing device 402 to tag tracking computing device 112 and are used to search a database for tagged transaction data including the specified tags. The results are sent from tag tracking computing device 112 to client computing device 402 along with instructions for output of the results via the user interface.

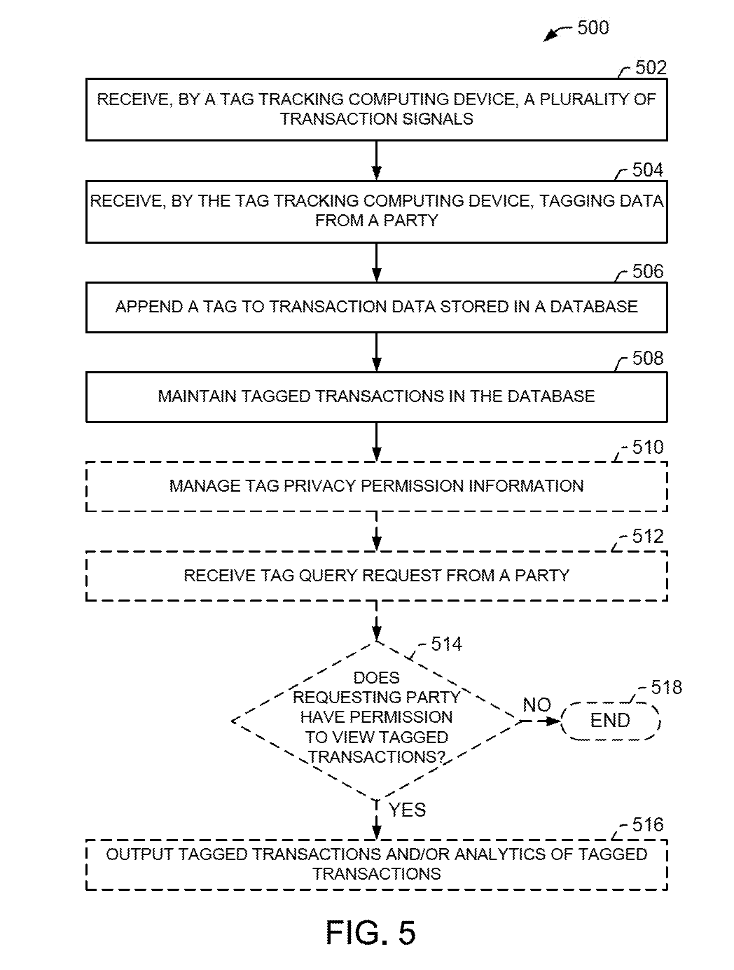

FIG. 5 is a simplified data flow diagram 500 for tagging transaction data using tag tracking computing device 112. As described herein, tag tracking computing device 112 receives a plurality of transaction signals 502. The transaction signals include transaction data which the tag tracking computing device 112 tags if the transaction data included in the transaction signals corresponds with criteria identifying transactions to be tagged. The tag tracking computing device 112 receives tagging data 40 from a party 504. For example, tag tracking computing device 112 receives tagging data 40 including a tag and criteria for identifying transactions to tag, and optionally including cardholder input data 34, from a party such as a merchant. The tag tracking computing device 112 appends the tag included in tagging data 40 to transaction data stored in a database 506. This includes tag tracking computing device 112 comparing the criteria identifying transactions to be tagged to the transaction data of the plurality of received transaction signals. If the transaction data of a transaction signal matches or meets the criteria then the tag tracking computing device appends the tag to the transaction data and stores the transaction data in the database including the tag (e.g., as a tuple including the transaction data and the tag). Tag tracking computing device can append tags retroactively or prospectively as described herein. The tag tracking computing device 112 further maintains (e.g., tracks) tagged transactions stored in the database 508. For example, tag tracking computing device periodically updates the database and tags additional transactions based on the tagging data. Additional transactions may be added to the database by tag tracking computing device 112 as they are received. Periodically, tag tracking computing device searches these additional transactions and determines if any of the transactions meet or satisfy the criteria for appending a tag. If so, a tag is appended and the database is maintained.

In some embodiments, tag tracking computing device performs further functions illustrated in data flow diagram 500 using broken lines. Tag tracking computing device 112 may manage tag privacy/permissions information 510. For example, tag tracking computing device 112 may receive new or updated tag tracking privacy/permissions information and apply this information to tagged transaction data stored in the database to control access to the tagged transaction data in accordance with the privacy/permissions information. Tag tracking computing device 112 may receive a tag query request from a party 512. The party making the tag query request may be the same party which providing the tagging data or may be a different party. The query includes a tag or tags for which the tag tracking computing device is to retrieve tagged transaction data and/or provide another output. The tag tracking computing device 112 searches the database of transaction data and retrieves entries which include the tag or tags. Included in those entries are the associated transaction data. The tag tracking computing device 112 may determine if the requesting party has permission to view the retrieved tagged transactions 514. For example, tag tracking computing device 112 may determine if the requesting party is listed on a white list included privacy/permissions information in the tagged transaction data. If the requesting party does not have permission to view the tagged transactions, tag tracking computing device 112 ends the process 518. If the requesting party does have permission to view the tagged transaction data, tag tracking computing device 112 outputs the tagged transaction data and/or another output such as analytics based on the tagged transaction data retrieved based on the tag(s) submitted in the query 516.

### Exemplary Embodiments

In an example embodiment, tags are used to track purchase related to a user's votes for a baseball all-star team lineup. Generally, a user (e.g., a cardholder 22) provides identifying information and a ballot for the all-star team lineup to a merchant 24 or other party (e.g., a baseball league). The party provides tagging data 40 to tag tracking computing device 112 which identifies all transactions including the cardholder identifying information as transactions to be tagged. The tag included in the tagging data 40 includes the players for which cardholder 22 has voted. At the end of a voting period, tag tracking computing device 112 provides an aggregate transaction amount for all transactions (e.g., transactions made by a plurality of cardholders 22) which are tagged with each player. Each dollar, or like currency, corresponds to a vote and the players with the highest number of votes are selected as the vote winners. In some embodiments, additional tags may be used to track transactions which occur at particular merchants such as team stores. Transaction amounts tagged with these tags may count towards an increased number of votes. For example every dollar, or like currency, spent at a team store may be worth two votes. Similar techniques may be used to assign increased number of votes to purchases of team merchandise (e.g., tags may be assigned for particular products which include team merchandise). In alternative embodiments, an aggregate transaction count is provided instead of an aggregate transaction amount for all transactions. In such a case, each completed transaction regardless of transaction amount is counted as a single vote for tagged players associated with each transaction. Transactions at team stores and or other particular merchants may be counted as more than one vote. Additional promotional features may be used in connection with the vote. For example, a party involved in the vote (e.g., merchants, the baseball league, the payment network provider, or the like) may make a donation to charity in the wining players' names, make a donation to the charities of choice of the winning players, or the like.

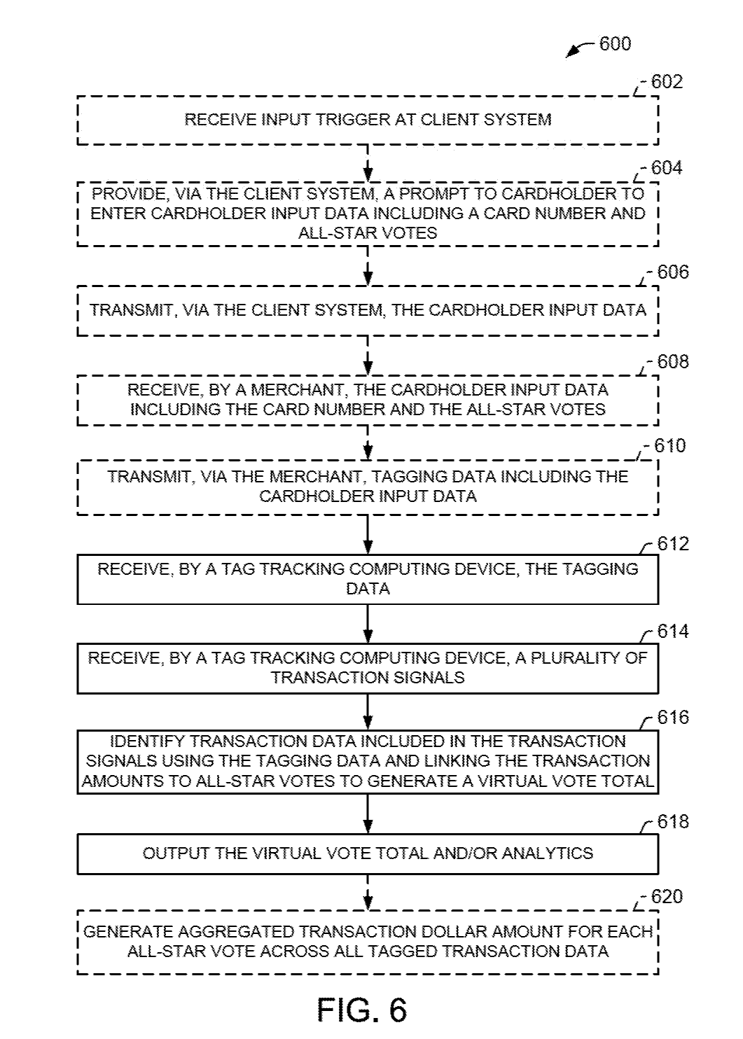

FIG. 6 is a simplified data flow diagram 600 for tagging transaction data in accordance with the above described exemplary embodiment. Flow steps shown in broken lines are optional. An input trigger 124 may be received by a user's client system 602. For example, a user (e.g., cardholder 22) may scan a quick reference code 128 with an application running on smartphone which causes the smartphone to launch an application or open a webpage. The application or web page provides a prompt to cardholder 22 to enter cardholder input data 34 including a card number and all-star player selections or votes 604. The player selections may be for all positions or a subset of the positions. The client system (e.g., the smartphone) transmits cardholder input data 34 including the card number and player selections 606. In one embodiment, the cardholder input data 34 is transmitted to a merchant 24 (e.g., the baseball league). In an alternative embodiment, cardholder input data 34 is transmitted to tag tracking computing device 112 directly.

Merchant 34 (e.g., the league) receives cardholder input data 34 including the card number and player selections (e.g., all-star team votes) 608. Merchant 34 transmits tagging data 40 including at least a portion of the cardholder input data 34, including the card number and player selections 610. Tagging data 40 identifies the card number as the transaction identification information and includes a tag generated based on the player selections.

Tag tracking computing device 112 receives the tagging data 34 which was transmitted 612. Tag tracking computing device 112 receives tagging data 34 corresponding to a plurality of users (e.g., cardholders 22) participating in the all-star voting process. Tag tracking computing device 112 receives a plurality of transaction signals 614. Some of the transaction signals correspond to transactions made by cardholders 22 participating in the all-star voting process and for which tag tracking computing device 112 has received corresponding tagging data 40. Tag tracking computing device 112 identifies transaction data included in the received plurality of transaction signals using the tagging data 40 previously received and links transaction amounts included in the tagged transaction data to all-star votes (e.g., player selections) included in each tag to generate a virtual vote total 616. Tag tracking computing device 112 determines whether to tag one of the plurality of received transaction signals by comparing the card number included in the transaction data to the card number included in each set of tagging data 40 as identifying transactions to tag. If two card numbers match, the transaction data associated with the transaction signal is tagged by appending the tag from the tagging data 40 to the transaction data, including transaction amount, and storing the transaction data and tag in a database. The virtual vote total may be an amount associated with each player, as indicated by the tag included in the identified transaction data. The identified transactions from a plurality of transactions may be aggregated based on the associated tags to determine the total dollar amount associated with each player, that received at least one vote, indicated by the tags associated with each identified transaction. Tag tracking computing device 112 outputs the virtual vote total and/or analytics generated using the tagged transaction data 618. In some embodiments, tag tracking computing device 112 outputs the virtual vote total, tagged transaction data, and/or analytics in response to receiving a request from the merchant (e.g., the league). In further embodiments, tag tracking computing device outputs the virtual vote total, tagged transaction data, and/or analytics periodically. This allows for a leaderboard to be maintained providing to users (e.g., cardholders 22) and/or others a vote count for each player in contention for a position on the all-star team, or a subset (e.g., top 3 vote earners for each position).

Using the output virtual vote total and/or tagged transaction data, the number of votes for each player can be determined by aggregating transaction amounts for each all-star vote across all of the transaction data 620. For example, each tagged transaction includes a transaction amount and a tag with each voted for player corresponding to the cardholder 22 of the transaction. The dollar amount is assigned to each player in the tag to determine a virtual vote total and added to a running total maintained (e.g., in a separate database) for each player. A modification of the transaction amount (e.g., double votes for completing a transaction with a team store) may be determined based on additional transaction data such as a merchant identifier and is completed before the amount is added to the running total for each player. Using the running total, a leader board may be maintained showing the current number of votes for each player corresponding to each position. This process is repeated for each tagged transaction of each cardholder 22 until all tagged transactions have been processed (e.g., over a period of time when cardholders can vote). Using the running total, the player with the highest total for each position can be selected as the vote winner. The vote winner may have a donation made in their name. In some embodiments, each player has a donation made in their name regardless of how they finish in the vote.

It should be noted that a baseball all-star team lineup is only one exemplary embodiment of the use of tag tracking computing device 112 and is not intended to be limiting. Similar systems and methods may be used in connection other sporting events, other voting systems, other contests, or the like.

This written description describes storing information as tuples. It should be understood that this is an exemplary embodiment. Tuples may include string entries, numerical entries, file location entries, files storing a plurality of information, pages, and/or other entries. In alternative embodiments, other database storage techniques may be used in place of, or in combination with, the use of tuples. For example, information may be stored in a database using a B+ tree structure, unordered structure, ordered structure, heap files structure, hash buckets structure, and/or other structure. Information may be stored such that entries of information are linked by any type of relationship corresponding to entries in the same tuple as described herein.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

In addition, although various elements of the tag tracking computing device are described herein as including general processing and memory devices, it should be understood that the tag tracking computing device is a specialized computer configured to perform the steps described herein for tagging transaction data and outputting information related to and/or including the tagged transaction data.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of tracking tagged transaction data corresponding to transactions between users and merchants, the method implemented using a tag tracking computing device in connection with a memory and a transaction processor, said method comprising:
receiving, by the tag tracking computing device, a plurality of transaction signals including a plurality of transaction data associated with the transactions;
receiving, by the tag tracking computing device, tagging data from a party, the tagging data including a tag and an identification of transaction data associated with a transaction; and
appending, by the tag tracking computing device, the tag to transaction data stored in a database based on the tagging data from the party.

2. The method of claim 1, wherein the tag is appended to at least a subset of the plurality of transaction data included in the plurality of received transaction signals as each of the plurality of transaction signals is received.

3. The method of claim 1, further comprising storing the plurality of transaction data received in the plurality of transaction signals in a database, wherein the tag is appended to at least a subset of the plurality of transaction data stored in the database after the received transaction data is first stored in the database.

4. The method of claim 1, wherein the tagging information includes the tag and transaction identification information, and wherein the transaction identification information includes criteria by which transaction data is selected to be tagged.

5. The method of claim 1, wherein the tagging information includes permissions information which determines which additional parties have access to tagged transaction data including the tag.

6. The method of claim 1, further comprising determining to append the tag to transaction data stored in the database by comparing transaction identification information in the tagging data to the transaction data stored in the database and determining that the transaction data matches the transaction identification information.

7. The method of claim 1 further comprising:
receiving, from a requesting party, a request for tagged transaction data including the tag;
searching the database for transaction data tagged with the tag; and
outputting a list of tagged transaction data.

8. The method of claim 7, wherein the requesting party is one of the party from which the tagging data is received and a different party.

9. The method of claim 7, further comprising determining that the requesting party has permission to receive the tagged transaction data by comparing an identifier of the requesting party to permission information included in the tag.

10. The method of claim 1, wherein the tag includes user input data provided by a user.

11. The method of claim 1, wherein the party is one or more of a cardholder, a merchant, and an issuing bank.

12. The method of claim 1, wherein the tag includes one or more of a purchase receipt, a product manual, a hyperlink, rewards program information, a recall notice, a warranty offer, and an advertisement.

13. The method of claim 1, wherein the identification of transaction data includes one or more of a primary account number, a temporary primary account number, a timestamp, a merchant identifier, and a payment card number.

14. A tag tracking computing device comprising at least one processor in communication with a memory, said tag tracking computing device in communication with a transaction processor, said at least one processor programmed to:
receive a plurality of transaction signals including a plurality of transaction data associated with the transactions;
receive tagging data from a party, the tagging data including a tag and an identification of transaction data associated with a transaction; and
append the tag to transaction data stored in a database based on the tagging data from the party.

15. The tag tracking computing device of claim 14, wherein the processor is programmed to append the tag to at least a subset of the plurality of transaction data included in the plurality of received transaction signals as each of the plurality of transaction signals is received.

16. The tag tracking computing device of claim 14, wherein the processor is further programed to:
store the plurality of transaction data received in the plurality of transaction signals in a database; and
append the tag to at least a subset of the plurality of transaction data stored in the database after the received transaction data is first stored in the database.

17. The tag tracking computing device of claim 14, wherein the tagging information includes the tag and transaction identification information, and wherein the transaction identification information includes criteria by which transaction data is selected to be tagged.

18. The tag tracking computing device of claim 14, wherein the tagging information includes permissions information which determines which additional parties have access to tagged transaction data including the tag.

19. The tag tracking computing device of claim 14, wherein the processor is further programmed to determine to append the tag to transaction data stored in the database by comparing transaction identification information in the tagging data to the transaction data stored in the database and determine that the transaction data matches the transaction identification information.

20. The tag tracking computing device of claim 14, wherein the processor is further programmed to:
receive, from a requesting party, a request for tagged transaction data including the tag;
search the database for transaction data tagged with the tag; and
output a list of tagged transaction data.

21. The tag tracking computing device of claim 20, wherein the requesting party is one of the party from which the tagging data is received and a different party.

22. The tag tracking computing device of claim 20, wherein the processor is further programmed to determine that the requesting party has permission to receive the tagged transaction data by comparing an identifier of the requesting party to permission information included in the tag.

23. The tag tracking computing device of claim 14, wherein the tag includes user input data provided by a user.

24. The tag tracking computing device of claim 14, wherein the party is one or more of a cardholder, a merchant, and an issuing bank.

25. The tag tracking computing device of claim 14, wherein the tag includes one or more of a purchase receipt, a product manual, a hyperlink, rewards program information, a recall notice, a warranty offer, and an advertisement.

26. The tag tracking computing device of claim 14, wherein the identification of transaction data includes one or more of a primary account number, a temporary primary account number, a timestamp, a merchant identifier, and a payment card number.
